(19) United States
(12) Patent Application Publication
(10) Pub. No.: US 2023/0283150 A1
(43) Pub. Date: Sep. 7, 2023

(54) MOTOR

(71) Applicant: LG INNOTEK CO., LTD., Seoul (KR)

(72) Inventors: Shung Hun WOO, Seoul (KR); Jung Soo YANG, Seoul (KR)

(21) Appl. No.: 18/007,834

(22) PCT Filed: Jun. 4, 2021
(86) PCT No.: PCT/KR2021/007010

§ 371 Date: Dec. 2, 2022

(30) Foreign Application Priority Data
Jun. 4, 2020 (KR) 10-2020-0067442
Dec. 4, 2020 (KR) 10-2020-0168297

(51) Int. Cl. H02K 11/215; H02K 7/08

(52) U.S. Cl. CPC H02K 11/215; H02K 7/08

(57) ABSTRACT

The present invention may provide a motor including a shaft, a rotor couped to the shaft, a stator disposed to correspond to the rotor, a sensing magnet coupled to the shaft, and a substrate including a sensor part disposed to correspond to the sensing magnet, wherein the sensing magnet includes an inner surface and an outer surface, the inner surface of the magnet is in contact with an outer surface of the shaft, and the sensor part is disposed further outward than the outer surface of the sensing magnet in a radial direction.

### TECHNICAL FIELD

The present invention relates to a motor.

### BACKGROUND ART

A motor includes a shaft, a rotor, and a stator. A sensing magnet may be disposed on the shaft to detect a position of the rotor. The sensing magnet rotates in conjunction with rotation of the rotor. A sensor disposed in the motor detects a change in magnetic flux according to the rotation of the sensing magnet. In the motor, the position of the rotor is checked based on the detected change in the magnetic flux.

The sensing magnet may be disposed on an end of the shaft. In addition, the sensor is disposed adjacent to the sensing magnet and to face the sensing magnet. Accordingly, the sensing magnet and the sensor are disposed in an axial direction.

However, in such a layout of the sensing magnet and the sensor, since the sensor should be aligned with a position of the shaft, there is a problem that there are many limitations in arranging a plurality of sensors in order to multiplexing the sensors. Particularly, since there is an insufficient space to install the sensors, when the plurality of sensors are arranged in the axial direction in order to solve the problem, distances from the sensors to the sensing magnet are different, and thus there is a problem of difficulty in accurately detecting the change in the magnetic flux of the sensing magnet.

In addition, there is a problem that an installation space of a bearing for supporting the shaft is limited.

In addition, the sensing magnet may be generally fixed to the shaft by a holder, and this method has a problem of increasing a length of a shafting due to the holder. In addition, there is a problem that sensing sensitivity of a magnetic element is degraded while the sensing magnet slips in the holder.

### Technical Problem

The present invention is directed to providing a motor in which a change in magnetic flux of a sensing magnet may be accurately detected while multiplexing sensors in order to detect a position of a rotor and a spatial limitation according to installation of a bearing may be significantly reduced.

In addition, the present invention is directed to providing a motor in which a length of a sensing magnet assembly in an axial direction decreases and a fixing force of a sensing magnet is improved.

Objectives to be achieved by the present invention are not limited to the above-described objectives, and other objectives which are not described above will be clearly understood by those skilled in the art through the following descriptions.

### Technical Solution

One aspect of the present invention provides a motor including a shaft, a rotor couped to the shaft, a stator disposed to correspond to the rotor, a sensing magnet coupled to the shaft, and a substrate including a sensor part disposed to correspond to the sensing magnet, wherein the sensing magnet includes an inner surface and an outer surface, the inner surface of the magnet is in contact with an outer surface of the shaft, and the sensor part is disposed further outward than the outer surface of the sensing magnet in a radial direction.

Another aspect of the present invention provides a motor including a shaft, a rotor couped to the shaft, a stator disposed to correspond to the rotor, a sensing magnet coupled to the shaft, and a substrate including a sensor part disposed to correspond to the sensing magnet, wherein the sensing magnet includes an inner surface and an outer surface, the inner surface of the magnet is in contact with an outer surface of the shaft, and the sensor part is not disposed to overlap the shaft in an axial direction in a range in which the sensor part is disposed within a radius of the rotor.

Still another aspect of the present invention provides a motor including a shaft, a rotor couped to the shaft, a stator disposed to correspond to the rotor, a sensing magnet coupled to the shaft, and a sensor part disposed to correspond to the sensing magnet, wherein the sensing magnet includes a first sensing magnet and a second sensing magnet which overlaps the first sensing magnet in an axial direction, and the sensor part includes a first sensor disposed to correspond to the first sensing magnet and a second sensor disposed to correspond to the second sensing magnet.

The motor may further include a bearing which supports the shaft, wherein a separation distance between the bearing and the rotor may be greater than a separation distance between the substrate and the rotor in an axial direction.

The substrate may be disposed between the sensing magnet and the bearing in the axial direction.

The substrate may be disposed between the sensing magnet and the rotor in the axial direction.

The sensor part may be disposed to face the outer surface of the sensing magnet.

Some of a plurality of sensor parts may be disposed on a first circumference about the shaft, and the rest of the plurality of sensor parts may be disposed on a second circumference.

Some of the plurality of sensor parts may be disposed to overlap in the radial direction.

The sensor parts may include a plurality of first sensors, some of the plurality of first sensors may be disposed to overlap the sensing magnet in the axial direction, and the rest of the plurality of first sensors may be disposed to overlap the sensing magnet in the radial direction.

The first sensor may be disposed on the first circumference about the shaft, and the second sensor may be disposed of the second circumference about the shaft.

The first sensor disposed on the first circumference and the second sensor disposed on the second circumference may be disposed not to overlap in the radial direction.

In the axial direction, the first sensing magnet may be disposed at one side of the substrate, and the second sensing magnet may be disposed at the other side of the substrate.

Each of the first sensor and the second sensor may be disposed to overlap the sensing magnet in the axial direction.

In the axial direction, the first sensor may be disposed at one side of the substrate, and the second sensor may be disposed at the other side of the substrate.

Yet another aspect of the present invention provides a motor including a shaft, a rotor coupled to the shaft, a stator disposed to correspond to the rotor, and a magnet disposed at one side of the shaft, wherein the shaft includes a protrusion disposed on a surface facing the magnet, and the magnet includes a space in which the protrusion is disposed.

The magnet may include a first pole and a second pole, and the protrusion may be disposed between the first pole and the second pole

The magnet may include a second hole in which the protrusion is disposed, and an inner surface of the second hole of the magnet may be in contact with at least one surface of the protrusion.

The first hole and the second hole may overlap in an axial direction.

Yet another aspect of the present invention provides a motor including a shaft, a rotor coupled to the shaft, a stator disposed to correspond to the rotor, a holder disposed at one side of the shaft, and a magnet disposed in the holder, wherein the shaft includes a protrusion disposed on a surface facing the magnet, the magnet includes a first magnet and a second magnet, and the protrusion is disposed between the first magnet and the second magnet.

The protrusion may be disposed in the holder, the holder may be divided into a first space and a second space based on the protrusion, the first magnet may be disposed in the first space, and the second magnet may be disposed in the second space.

A distance between the first magnet and the first magnet may be the same as a thickness of the protrusion.

The protrusion may have a first thickness in a first direction and a second thickness in a second direction perpendicular to the first direction, and the first thickness may be greater than the second thickness.

The center of a width of the protrusion may overlap an axis of the shaft.

A cross section of the protrusion in a direction perpendicular to an axial direction may have a triangular, quadrangular, or semi-circular shape.

The holder may include a first part through which the protrusion passes and a second part which extends from the first part in the axial direction and surrounds an outer circumferential surface of the magnet.

A thickness of the first part in the axial direction may be smaller than a length of the protrusion in the axial direction.

### Advantageous Effects

According to embodiments, there are advantages that a change in magnetic flux of a sensing magnet can be accurately detected while multiplexing sensors, and a spatial limitation according to installation of a bearing can be significantly reduced.

According to the embodiments, the spatial limitation according to installation of the bearing can be significantly reduced.

According to the embodiments, an installation space between a magnet holder and a shaft can be reduced, and a size of a motor in an axial direction can be reduced. In addition, slip of a magnet can be prevented by physically fixing the magnet to the shaft, and the detection performance of a magnetic element can be improved.

### DESCRIPTION OF DRAWINGS

FIG. 1 is a view illustrating a motor according to an embodiment.

FIG. 2 is a view illustrating a sensing magnet and a sensor part illustrated in FIG. 1.

FIG. 3 is a perspective view illustrating the sensing magnet illustrated in FIG. 2.

FIG. 4 is a plan view illustrating a position of the sensing magnet and a position of the sensor part.

FIG. 5 is a side view illustrating a plurality of sensor parts and the sensing magnet.

FIG. 6 is a plan view illustrating the plurality of sensor parts and the sensing magnet illustrated in FIG. 5.

FIG. 7 is a side view illustrating the sensor parts disposed to overlap the sensing magnet in an axial direction and the sensor parts disposed to overlap the sensing magnet in a radial direction.

FIG. 8 is a side view illustrating a first sensor, a second sensor, a first sensing magnet, and a second sensing magnet.

FIG. 9 is a plan view illustrating the second sensing magnet.

FIG. 10 is a side view illustrating a motor including a sensing part disposed between the first sensing magnet and the second sensing magnet in the axial direction.

FIG. 11 is a cross-sectional view illustrating a motor according to one embodiment of the present invention.

FIG. 12 is a perspective view illustrating a state in which a holder and a magnet are disposed on an end portion of a shaft according to one embodiment of the present invention.

FIG. 13 is an exploded perspective view illustrating the shaft, the holder, and the magnet according to one embodiment of the present invention.

FIGS. 14 and 15 are side views illustrating the end portion of the shaft according to one embodiment of the present invention.

FIG. 16 is a plan view illustrating the magnet according to one embodiment of the present invention.

FIG. 17 is a cross-sectional view illustrating the shaft, the holder, and the magnet according to one embodiment of the present invention.

FIG. 18 is a perspective view illustrating a state in which a holder and a magnet are installed on a shaft according to another embodiment of the present invention.

FIG. 19 is an exploded perspective view illustrating the shaft, the holder, and the magnet according to another embodiment of the present invention.

FIGS. 20 and 21 are side views illustrating an end portion of the shaft according to another embodiment of the present invention.

FIG. 22 is a plan view illustrating the holder according to another embodiment of the present invention.

FIG. 23 is a cross-sectional view illustrating the shaft, the holder, and the magnet according to another embodiment of the present invention.

### MODES OF THE INVENTION

Hereinafter, exemplary embodiments of the present invention will be described in detail with reference to the accompanying drawings.

However, the technical spirit of the present invention is not limited to some embodiments which will be described and may be realized using various other embodiments, and at least one component of the embodiments may be selectively coupled, substituted, and used within the range of the technical spirit of the present invention.

In addition, unless clearly and specifically defined otherwise by context, all terms (including technical and scientific terms) used herein can be interpreted as having meanings customarily understood by those skilled in the art, and meanings of generally used terms, such as those defined in commonly used dictionaries, will be interpreted by considering contextual meanings of the related technology.

In addition, the terms used in the embodiments of the present invention are considered in a descriptive sense and not for limiting the present invention.

In the present specification, unless specifically indicated otherwise by the context, singular forms may include the plural forms thereof, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” can be used.

The terms are only to distinguish one element from another element, and an essence, order, and the like of the element are not limited by the terms.

In addition, when an element is referred to as being “connected” or “coupled” to another element, such a description may include not only a case in which the element is directly connected or coupled to another element but also a case in which the element is connected or coupled to another element with still another element disposed therebetween.

In addition, in a case in which any one element is described as being formed or disposed “on” or “under” another element, such a description includes not only a case in which the two elements are formed or disposed in direct contact with each other but also a case in which one or more other elements are formed or disposed between the two elements. In addition, when one element is described as being disposed “on or under” another element, such a description may include a case in which the one element is disposed at an upper side or lower side with respect to another element.

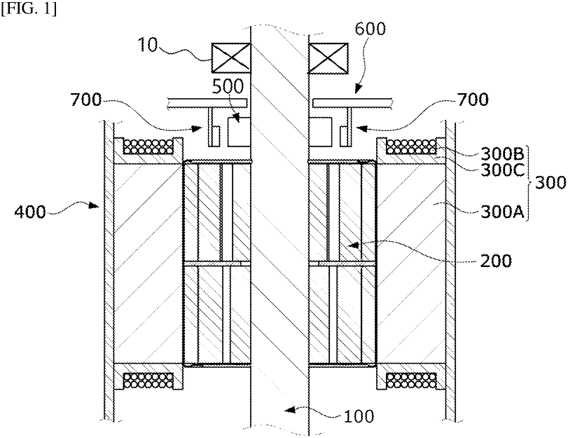

FIG. 1 is a view illustrating a motor according to an embodiment.

Referring to FIG. 1, the motor according to the embodiment may include a shaft 100, a rotor 200, a stator 300, and a housing 400. Hereinafter, the term “inward” refers to a direction from the housing 400 toward the shaft 100 which is a center of the motor, and the term “outward” refers to a direction opposite to “inward,” that is, a direction from the shaft 100 toward the housing 400. In addition, hereinafter, a circumferential direction or radial direction is defined based on an axial center.

The shaft 100 may be coupled to the rotor 200. When a current is supplied and an electromagnetic interaction between the rotor 200 and the stator 300 occurs, the rotor 200 rotates, and the shaft 100 rotates in conjunction with the rotation of the rotor 200. The shaft 100 may be supported by a bearing 10.

The rotor 200 rotates due to an electrical interaction with the stator 300. The rotor 200 may be disposed inside the stator 300 to correspond to the stator 300. The rotor 200 may include a magnet.

The stator 300 disposed outside the rotor 200. The stator 300 may include a stator core 300A, an insulator 300B, and a coil 300C. The insulator 300B is disposed on the stator core 300A. The coil 300C may be wound around the insulator 300B. The insulator 300B disposed between the coil 300C and the stator core 300A to electrically insulate the stator core 300A from the coil 300C. The coil 300C induces an electrical interaction with the magnet of the rotor 200.

The housing 400 may be disposed outside the stator 300.

A sensing magnet 500 is coupled to the shaft 100. When the rotor 200 rotates, the sensing magnet 500 also rotates in conjunction with the rotation of the rotor 200.

A sensor part 700 is disposed on a substrate 600.

The sensor part 700 is disposed on the substrate 600 and detects a change in magnetic flux according to the rotation of the sensing magnet 500.

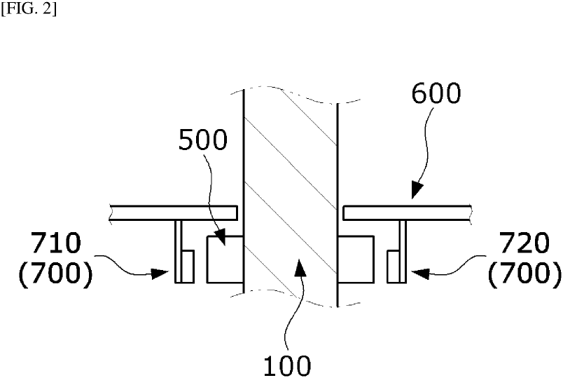

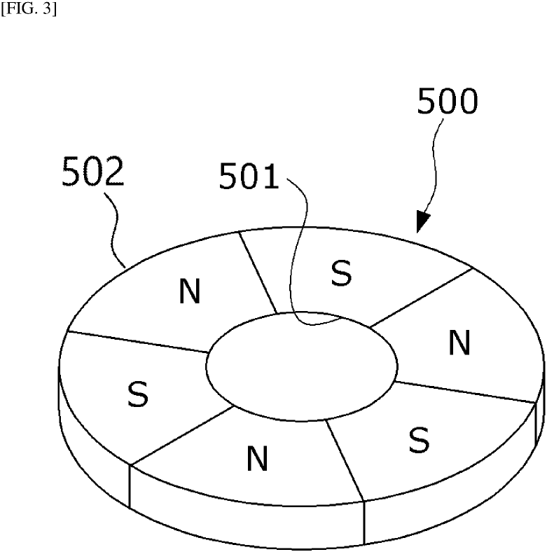

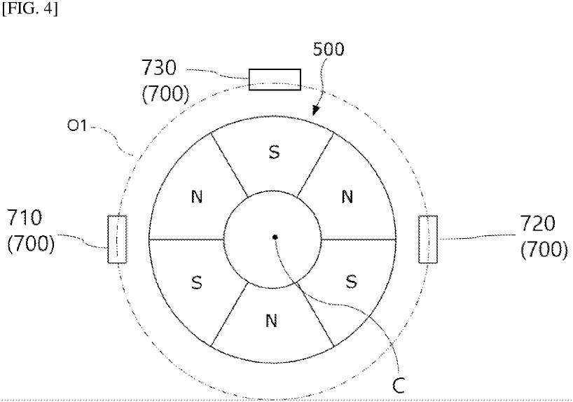

FIG. 2 is a view illustrating the sensing magnet 500 and the sensor part illustrated in FIG. 1, FIG. 3 is a perspective view illustrating the sensing magnet 500 illustrated in FIG. 2, and FIG. 4 is a plan view illustrating a position of the sensing magnet 500 and a position of the sensor part 700.

Referring to FIGS. 1 to 4, the sensing magnet 500 may be a hollow member including an inner surface 501 and an outer surface 502. N-poles and S-poles may be alternately disposed in the sensing magnet 500 in a circumferential direction. The number of poles of the sensing magnet 500 may be greater than or equal to the number of the magnet of the rotor 200. The sensing magnet 500 may be directly fixed to the shaft 100. The inner surface 501 of the sensing magnet 500 is in contact with an outer surface of the shaft 100.

The sensor part 700 may be disposed not to overlap the shaft 100 in an axial direction within a range in which the sensor part 700 is disposed within a radius of the rotor 200. In a radial direction, the sensor part 700 may be disposed further outward than the outer surface 502 of the sensing magnet 500. For example, the sensor part 700 may be disposed to face the outer surface 502 of the sensing magnet 500.

Since the sensing magnet 500 is not disposed on an end of the shaft 100, the sensor part 700 does not need to be aligned with the shaft 100. Accordingly, the sensor part 700 may be disposed in a wider space outside a radius range of the shaft 100. Accordingly, a space for arranging a plurality of sensor parts 700 for multiplexing can be sufficiently secured.

In addition, since the sensing magnet 500 is not disposed on the end of the shaft 100, the shaft 100 may be disposed to protrude further than the sensing magnet 500 and pass through the substrate 600 in the axial direction. A separation distance between the sensing magnet 500 and the substrate 600 can be significantly reduced in the axial direction. Accordingly, a length of the motor in the axial direction can be reduced.

In the axial direction, the bearing 10 may be disposed so that a separation distance between the bearing 10 and the rotor 200 is greater than a separation distance between the substrate 600 and the rotor 200. Accordingly, the bearing 10 may be disposed outside the substrate 600 in the axial direction based on the rotor 200. When the bearing 10 is disposed between the substrate 600 and the rotor 200 in the axial direction, an installation space of the bearing 10 is very small, and there is a possibility in which a structure of a plate or the housing supporting the bearing 10 is complex, but, when the bearing 10 is disposed further outward than the substrate 600, there is a great advantage that a space between the substrate 600 and the rotor 200 can be utilized in the axial direction while designing the motor, and the structure of the plate or the housing supporting the bearing 10 can be very simplified.

Meanwhile, the sensor parts 700 may include a plurality of sensor parts 710, 720, and 730 for multiplexing. The plurality of sensor parts 710, 720, and 730 may be disposed at predetermined intervals in the circumferential direction about an axial center C. For example, the plurality of sensor parts 710, 720, and 730 may be disposed on a first circumference O1 about the axial center C. In addition, since a plurality of first sensors 700A may be disposed so that distances from the sensing magnet 500 are the same in the axial direction, each of the plurality of first sensors 700A may detect a change in magnetic flux according to rotation of the sensing magnet 500 under the same condition. There is an advantage that a multiplexing design in various methods can be easily performed through sensing signals generated from the detected change in the magnetic flux.

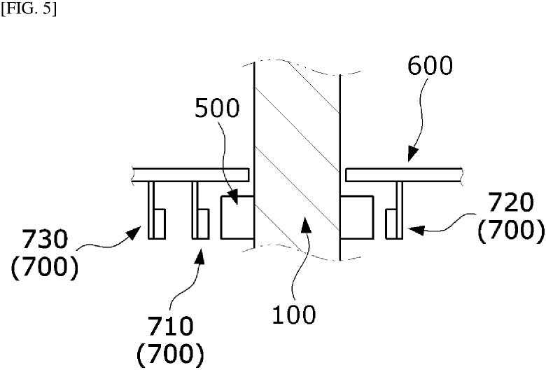

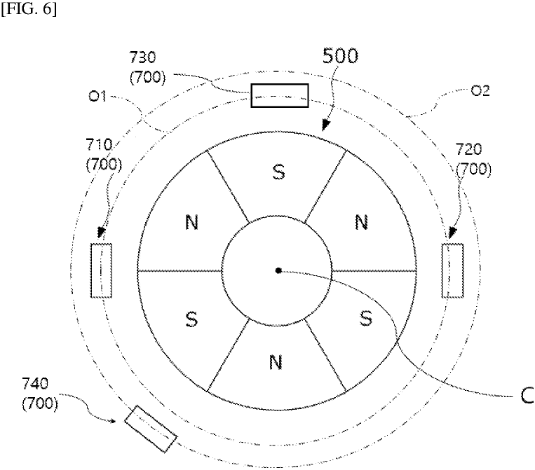

FIG. 5 is a side view illustrating the plurality of sensor parts 700 and the sensing magnet 500, and FIG. 6 is a plan view illustrating the plurality of sensor parts 700 and the sensing magnet 500 illustrated in FIG. 5.

Referring to FIGS. 5 and 6, some of the sensor parts 710, 720, and 730 among a plurality of sensor parts 710, 720, 730, and 740 may be disposed on the first circumference O1, and the sensor part 740 among the plurality of sensor parts 710, 720, 730, and 740 may be disposed on a second circumference O2 about the axial center C. A radius of the second circumference O2 may be different from a radius of the first circumference O1. In this case, the sensor part 740 disposed on the first circumference O1 and the sensor parts 710, 720, and 730 disposed on the second circumference O2 may be disposed at the same distance from the sensing magnet 500 in the axial direction, but the sensor parts 710, 720, and 730 disposed on the first circumference O1 may be disposed not to overlap the sensor part 740 disposed on the second circumference O2 in the radial direction.

As the sensor parts 710, 720, 730, and 740 of which distances from the sensing magnet 500 are different in the radial direction are disposed, there is an advantage that a multiplexing design in more various methods is easily performed.

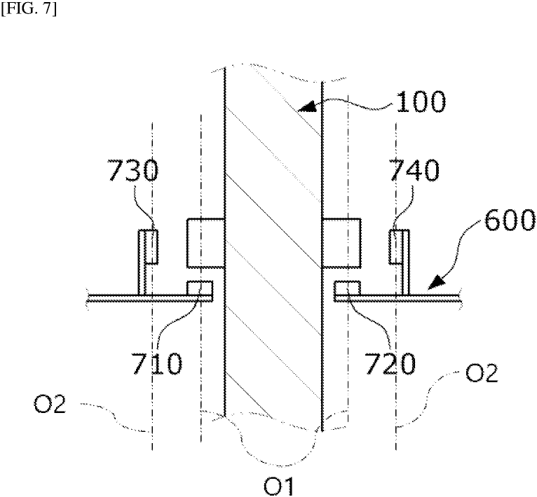

FIG. 7 is a side view illustrating the sensor parts 710 and 720 disposed to overlap the sensing magnet 500 in the axial direction and the sensor parts 730 and 740 disposed to overlap the sensing magnet 500 in the radial direction.

Referring to FIG. 7, some sensor parts 710 and 720 of the plurality of sensor parts 710, 720, 730, and 740 may be disposed to overlap the sensing magnet 500 in the axial direction.

The sensor parts 710 and 720 may be disposed between the substrate 600 and the sensing magnet 500 in the axial direction. The sensor parts 710 and 720 may be disposed on the first circumference O1.

The sensor parts 730 and 740 among the plurality of sensor parts 710, 720, 730, and 740 may be disposed to overlap the sensing magnet 500 in the radial direction. The sensor parts 730 and 740 may be disposed to face the outer surface 502 of the sensing magnet 500. The sensor parts 730 and the 740 may be disposed on the second circumference O2 having the radius different from the radius of the first circumference O1.

The above-described configuration is useful to increase the number of the sensor parts 700 when a space for arranging the sensor parts 700 outside the sensing magnet 500 in the radial direction is insufficient.

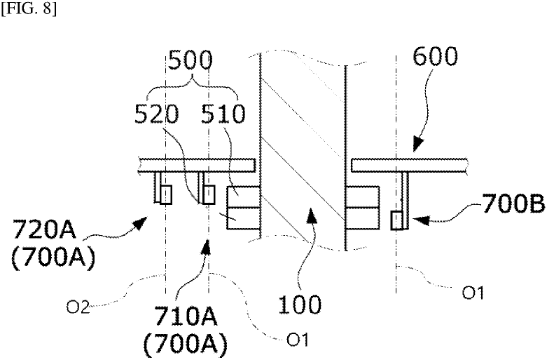

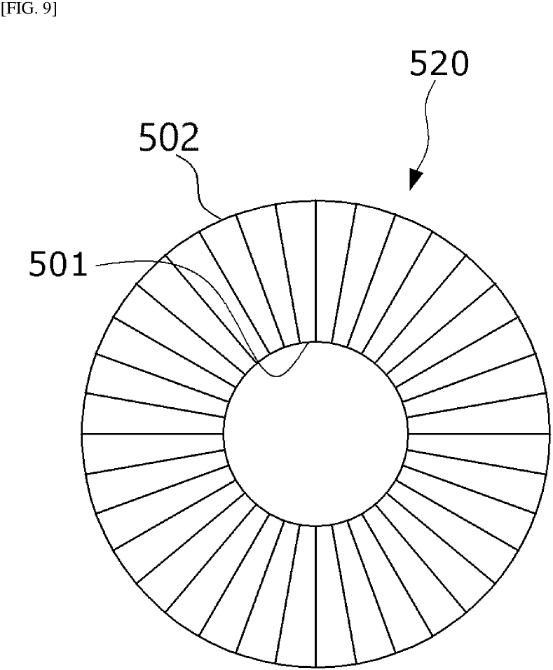

FIG. 8 is a side view illustrating a first sensor 700A, a second sensor 700B, a first sensing magnet 510, and a second sensing magnet 520, and FIG. 9 is a plan view illustrating the second sensing magnet 520.

Referring to FIGS. 8 and 9, the sensing magnet 500 may include the first sensing magnet 510 and the second sensing magnet 520. When the first sensing magnet 510 and the second sensing magnet 520 are fixed to the shaft 100, the first sensing magnet 510 and the second sensing magnet 520 may be disposed to overlap in the axial direction. When the rotor 200 rotates, the first sensing magnet 510 and the second sensing magnet 520 rotate together.

The first sensing magnet 510 may have the same number of poles as that of the magnet of the rotor 200 in order to directly check a position of the rotor 200. For example, the number of the poles of the magnet of the rotor 200 is 6, the number of the poles of the first sensing magnet 510 may also be 6. In such a first sensing magnet 510, since regions in which the poles are divided are aligned with those of the magnet of the rotor 200, an initial position of the rotor 200 is easily checked.

The second sensing magnet 520 may have the number of poles greater than the number of the poles of the magnet of the rotor 200. For example, the number of the poles of the second sensing magnet 520 may be 72. Such a second sensing magnet 520 is easy to precisely check the detailed position of the rotor 200.

The second sensing magnet 520 may be a hollow member having an inner surface 501 and an outer surface 502. The inner surface 501 of the second sensing magnet 520 is in contact with the outer surface of the shaft 100.

The first sensor 700A detects a change in magnetic flux according to rotation of the first sensing magnet 510. The first sensor 700A may be disposed to face an outer surface 502 of the first sensing magnet 510.

The second sensor 700B detects a change in magnetic flux according to rotation of the second sensing magnet 520. The second sensor 700B may be disposed to face the outer surface 502 of the second sensing magnet 520.

Both of the first sensor 700A and the second sensor 700B may be disposed on the first circumference O1. Meanwhile, when a plurality of first sensors 700A are disposed, some of the plurality of first sensors 700A may be disposed on the first circumference O1, and the rest of the plurality of first sensors 700A may be disposed on the second circumference O2 about the axial center C.

In such a motor, the sensing magnet 500 may be added according a design condition in the axial direction, and accordingly, a space for adding the sensor part 700 is also sufficiently secured, and thus there is an advantage that a multiplexing design is very easily performed.

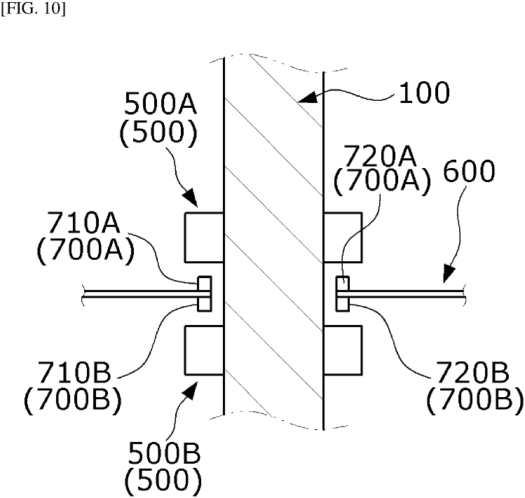

FIG. 10 is a side view illustrating the motor including the sensor part 700 disposed between the first sensing magnet 510 and the second sensing magnet 520 in the axial direction.

Referring to FIG. 10, the first sensing magnet 510 may be disposed at one side of the substrate 600, and the second sensing magnet 520 may be disposed at the other side of the substrate 600 in the axial direction. That is, the first sensing magnet 510 and the second sensing magnet 520 may be disposed apart from each other in the axial direction, and the substrate 600 may be disposed between the first sensing magnet 510 and the second sensing magnet 520.

The sensor part 700 may be disposed to overlap the sensing magnet 500 in the axial direction. For example, the first sensors 700A (710A and 720A) may be disposed to overlap the first sensing magnet 510 in the axial direction. In addition, second sensors 700B (710B and 720B) may be disposed to overlap the second sensing magnet 520 in the axial direction. The first sensor 700A may be disposed at one side of the substrate 600 in the axial direction. In addition, the second sensor 700B may be disposed at the other side of the substrate 600 in the axial direction.

Accordingly, there is an advantage that the first sensing magnet 510 can be disposed using a space between the substrate 600 and the bearing 10 (see FIG. 1) when a space between the substrate 600 and the rotor 200 is small in the axial direction. In addition, such a configuration may be useful when a space for arranging the sensor part 700 outside the sensing magnet 500 in the radial direction is insufficient.

In addition, in such a configuration, since the first sensing magnet 510 and the second sensing magnet 520 are disposed with a gap and the substrate 600 which are interposed therebetween, there is an advantage that a magnetic field interference between the first sensing magnet 510 and the second sensing magnet 520 can be significantly reduced.

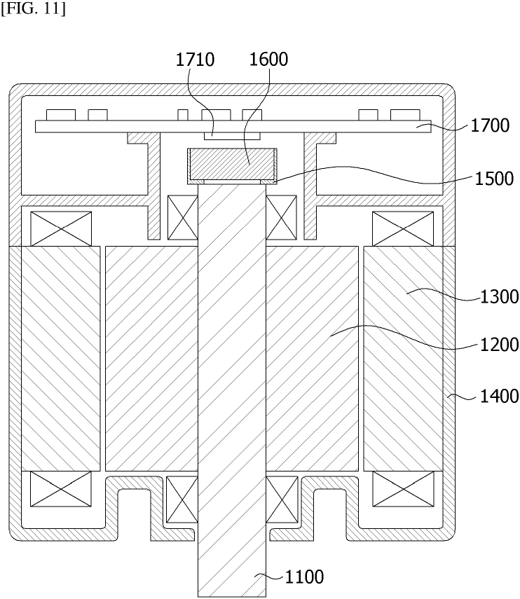

FIG. 11 is a cross-sectional view illustrating a motor according to one embodiment of the present invention.

Referring to FIG. 11, the motor includes a shaft 1100, a rotor 1200, a stator 1300, a housing 1400, a holder 1500, a magnet 1600, and a circuit substrate 1700.

Hereinafter, the term “inward” refers to a direction from the housing 1400 toward the shaft 1100 which is a center of the motor, and the term “outward” refers to a direction opposite to “inward,” that is, a direction from the shaft 1100 toward the housing 1400.

The shaft 1100 may be coupled to the rotor 1200. When a current is supplied and an electromagnetic interaction between the rotor 1200 and the stator 1300 occurs, the rotor 1200 rotates, and the shaft 1100 rotates in conjunction with the rotation of the. The shaft 1100 may be connected to a steering apparatus of a vehicle to transmit power to the steering apparatus.

The rotor 1200 rotates due to an electrical interaction with the stator 1300. The rotor 1200 may be disposed inside the stator 1300. The rotor 1200 may include a rotor core and a rotor magnet disposed on the rotor core.

The stator 1300 is disposed outside the rotor 1200. The stator 1300 may include a stator core, a coil, and an insulator installed on the stator core. The coil may be wound around the insulator. The insulator is disposed between the coil and the stator core. The coil induces an electrical interaction with the rotor magnet.

The housing 1400 may be disposed outside the stator 1300. The housing 1400 may be a hollow member having one open side. The shape or material of the housing 1400 may be variously changed, and a metal material which can endure well even at high temperatures may be selected for the housing 1400.

The holder 1500 is coupled to the shaft. The holder 1500 rotates in conjunction with the rotor 1200 and the shaft 1100. The holder 1500 may be formed of a non-magnetic material.

The magnet 1600 is coupled to the shaft 1100 to operate in conjunction with the rotor 1200. The magnet 1600 is a device configured to detect a position of the rotor 1200.

The circuit substrate 1700 may be disposed apart from the shaft 1100. The circuit substrate 1700 may be a printed circuit board (PCB). In addition, a sensor 1710 may be mounted on the circuit substrate 1700. The sensor 1710 may be disposed to face the magnet 1600. The sensor 1710 may be spaced apart from the magnet 1600. The sensor 1710 may be a Hall integrated circuit (IC). The sensor 1710 may detect a change in an N-pole and an S-pole of the magnet 1600 to generate a sensing signal.

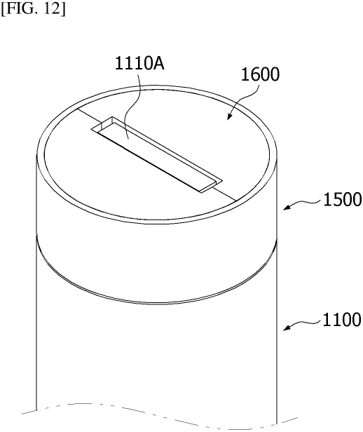

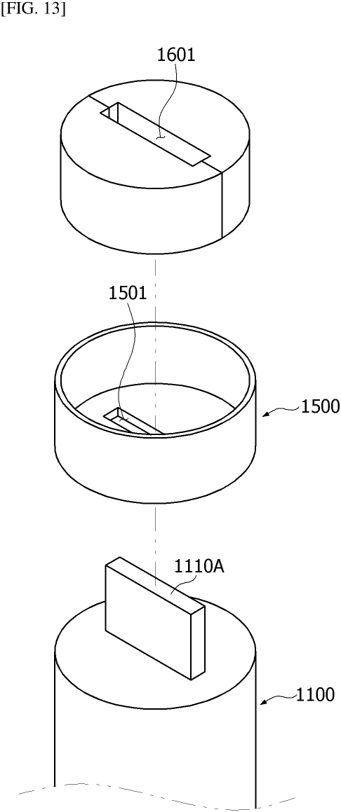

FIG. 12 is a perspective view illustrating a state in which the holder and the magnet are disposed on an end portion of the shaft according to one embodiment of the present invention, and FIG. 13 is an exploded perspective view illustrating the shaft, the holder, and the magnet according to one embodiment of the present invention.

Referring to FIGS. 12 and 13, the holder 1500 is disposed on an end portion of the shaft 1100. In addition, the magnet 1600 is disposed in the holder 1500. The magnet 1600 and the shaft 1100 may be disposed in an axial direction. The magnet 1600 may be an annular magnet. The magnet 1600 is fixed to the end portion of the shaft 1100. In this case, the shaft 1100 may include a protrusion 1110A. The protrusion 1110A may protrude from the end portion of the shaft 1100 in the axial direction. A width of the protrusion 1110A may be smaller than a diameter of the shaft 1100.

The holder 1500 may include a first hole 1500H. The protrusion 1110A passes through the first hole 1500H. An end portion of the protrusion 1110A passes through the first hole 1500H to protrude toward the magnet 1600. The magnet 1600 includes a space in which the protrusion 1110A is disposed.

The magnet 1600 may include a second hole 1600H. The space of the magnet 1600 may be formed due to the second hole 1600H. The second hole 1600H may overlap the first hole 1500H in the axial direction. In this case, a cross-sectional shape of the protrusion 1110A may be the same as a cross-sectional shape of each of the first hole 1500H and the second hole 1600H. In this case, a cross section of the protrusion 1110A in the axial direction may have a triangular, quadrangular, or semi-circular shape. Preferably, a cross-section of the protrusion 1110A in a direction perpendicular to the axial direction may have a quadrangular shape.

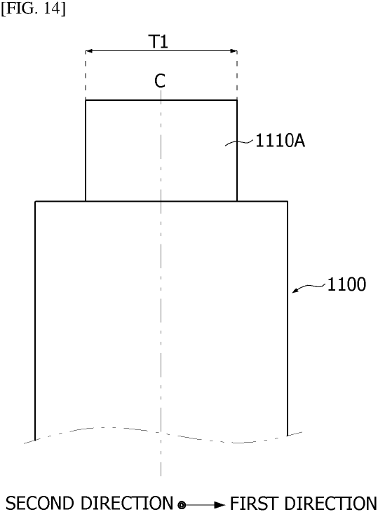

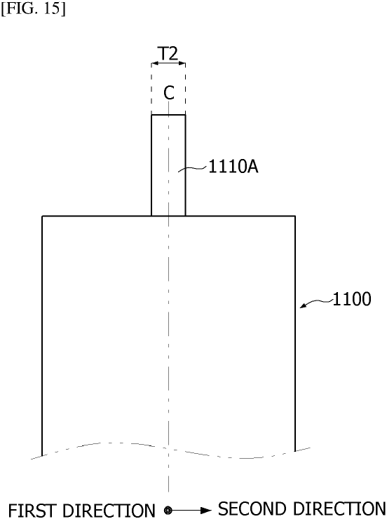

FIGS. 14 and 15 are side views illustrating the end portion of the shaft according to one embodiment of the present invention.

Referring to FIGS. 14 and 15, the shaft 1100 includes the protrusion 1110A. The protrusion 1110A extends from the end portion of the shaft 1100. The protrusion 1110A may be provided as at least one protrusion 1110A. The center of a width of the protrusion 1110A may overlap an axis C of the shaft 1100. The protrusion 1110A may have a first thickness T1 in a first direction and a second thickness T2 in a second direction. In addition, the first thickness T1 may be greater than the second thickness T2. A cross section of the protrusion 1110A may have a rectangular shape in a direction perpendicular to the axial direction. In this case, a ratio of the diameter of the shaft 1110 to the first thickness T1 may be in the range of 0.3 to 0.8. Meanwhile, although not illustrated in the drawings, a shape of the thickness of the protrusion in the first direction may be the same as a shape of the thickness in the second direction. In this case, the cross section of the protrusion 1110A in a direction perpendicular to the axial direction may have a square shape.

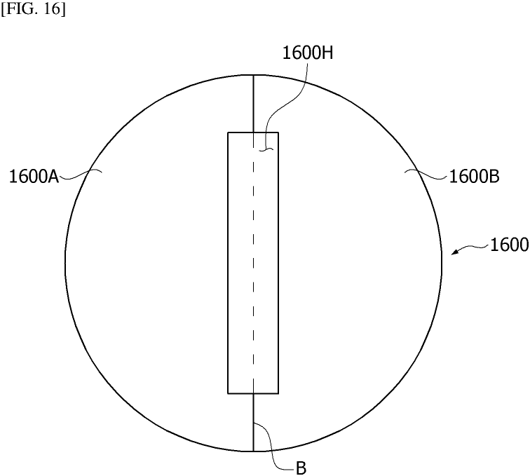

FIG. 16 is a plan view illustrating the magnet according to one embodiment of the present invention.

Referring to FIG. 16, the magnet 1600 may include a first pole 1600A and a second pole 1600B. The first pole 1600A may be an N-pole. In addition, the second pole 1600B may be an S-pole. In this case, in the magnet 1600, a boundary surface B may be formed between the first pole 1600A and the second pole 1600B. The boundary surface B is a portion which actually does not have magnetic properties, includes a section with little polarity, and is naturally formed to form a magnet including one N-pole and one S-pole. The boundary surface B may be referred to as a neutral zone. In addition, the second hole 1600H may be formed in the boundary surface B between the first pole 1600A and the second pole 1600B. That is, the second hole 1600H may be disposed between the first pole 1600A and the second pole 1600B. As described above, the hole may be formed in the boundary surface between the two poles of the magnet to minimize loss of a magnetic force.

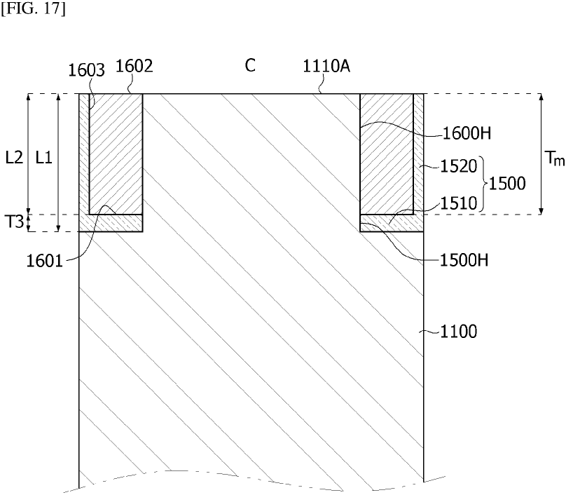

FIG. 17 is a cross-sectional view illustrating the shaft, the holder, and the magnet according to one embodiment of the present invention.

Referring to FIG. 17, the holder 1500 may include a first part 1510 and a second part 1520.

The protrusion 1110A passes through the first part 1510. The first part 1510 may be disposed between the magnet 1600 and the shaft 1100. Based on the drawing, an upper surface of the first part 1510 may be in contact with the magnet 1600, and a lower surface of the first part 1510 may be in contact with the end portion of the shaft 1100. In this case, the first part 1510 may support the magnet 1600 in the axial direction. The first hole 1500H may be disposed in the first part 1510. In addition, the protrusion 1110A may passes through the first hole 1500H. In this case, a thickness T3 of the first part 1510 in the axial direction may be smaller than a length L1 of the protrusion 1110A in the axial direction. Accordingly, the end portion of the protrusion 1110A my pass through the first part 1510 to protrude toward the magnet 1600.

The second part 1520 extends from the first part 1510. In addition, the second part 1520 is disposed outside the magnet 1600. In this case, the first part 1510 and the second part 1520 may form a space in which the magnet 1600 is disposed. The second part 1520 may surround an outer circumferential surface of the magnet 1600. In this case, the second part 1520 may support the magnet 1600 in a radial direction. A length L2 of the second part 1520 in the axial direction may be smaller than the length L1 of the protrusion 1110A of the magnet 1600 in the axial direction. In addition, the length L2 of the second part 1520 in the axial direction may be smaller than or equal to a thickness Tm of the magnet 1600 in the axial direction. In this case, an upper end of the second part 1520 may be disposed at a lower level than an upper surface of the magnet 1600.

The magnet 1600 may include a first surface 1601, a second surface 1602, and a third surface 1603. The first surface 1601 and the second surface 1602 are disposed in the axial direction. The first surface 1601 is disposed toward the shaft 1100. In this case, the first surface 1601 may be in contact with the first part 1510. The second surface 1602 is a surface opposite to the first surface 1601. The second surface 1602 may face the sensor 1710 illustrated in FIG. 12. The third surface 1603 may connect the first surface 1601 and the second surface 1602. The third surface 1603 may be a curved surface. In this case, the third surface 1603 may be in contact with an inner surface of the second part 1520.

The magnet 1600 may include the second hole 1600H. The second hole 1600H may pass through the first surface 1601 and the second surface 1602. In this case, the second hole 1600H may be provided as at least one second hole 1600H. The second hole 1600H is disposed to overlap the first hole 1500H in the axial direction. In this case, the sum of a length of the first hole 1500H and a length of the second hole 1600H in the axial direction may be greater than or equal to the length L1 of the protrusion 1110A in the axial direction. In this case, when the sum of the length of the first hole 1500H and the length of the second hole 1600H in the axial direction is greater than the length L1 of the protrusion 1110A in the axial direction, an upper end of the protrusion 1110A may be disposed at a lower level than the second surface 1602.

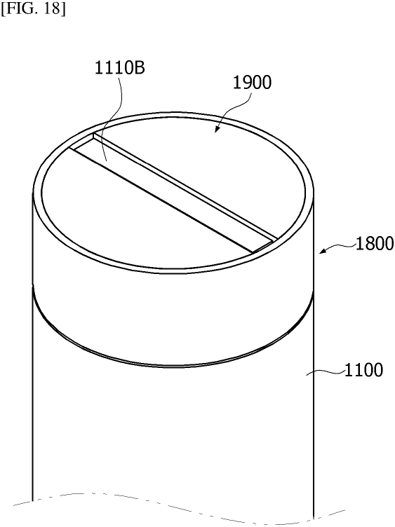

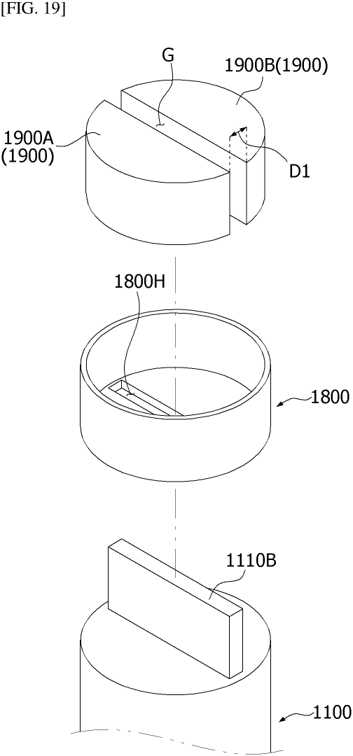

FIG. 18 is a perspective view illustrating a state in which a holder and a magnet are installed on a shaft according to another embodiment of the present invention, and FIG. 19 is an exploded perspective view illustrating the shaft, the holder, and the magnet according to another embodiment of the present invention.

Referring to FIGS. 18 and 19, a shaft 1100 includes a protrusion 1110B. The protrusion 1110B extends from an end portion of the shaft 1100. In addition, a holder 1800 may be disposed at one side of the shaft 1100. In this case, the holder 1800 includes a first hole 1800H. The protrusion 1110B passes through the first hole 1800H. In addition, an end portion of the protrusion 1110B passing through the first hole 1800H may protrude toward a magnet 1900. The magnet 1900 may be disposed in the holder 1800.

The magnet 1900 may include a first magnet 1900A and a second magnet 1900B. The first magnet 1900A and the second magnet 1900B may be different parts separated from each other. In this case, the first magnet 1900A may have an N-pole. In addition, the second magnet 1900B may have an S-pole. The magnet 1900 includes a space G in which the protrusion 1110B is disposed. The protrusion 1110B passing through the first hole 1800H may be disposed in the space G of the magnet 1900. The space G of the magnet 1900 may be a space between the first magnet 1900A and the second magnet 1900B which are spaced apart from each other. In this case, a separation distance D1 between the first magnet 1900A and the second magnet 1900B may be the same as a thickness of the protrusion 1110B.

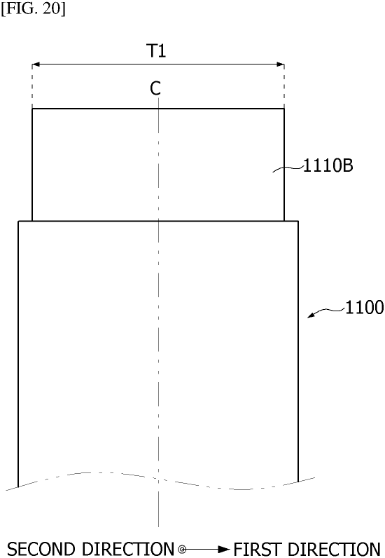

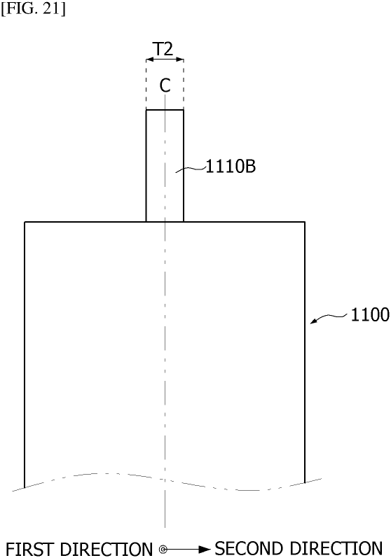

FIGS. 20 and 21 are side views illustrating the end portion of the shaft according to another embodiment of the present invention.

The protrusion 1110B may be disposed on the end portion of the shaft 1100. The protrusion 1110B may be provided as at least one protrusion 1110B. The center of a width of the protrusion 1110B may overlap an axis C of the shaft 1100. In this case, the protrusion 1110B may have a first thickness T1 in a first direction and a second thickness T2 in a second direction. The first thickness T1 may be greater than the second thickness T2. In this case, a cross section of the protrusion 1110B in a direction perpendicular to an axial direction may have a rectangular shape. In this case, a ratio of a diameter of the shaft 1110 to the first thickness T1 may be in the range of 0.8 to 1. Meanwhile, although not illustrated in the drawings, a shape of the thickness of the protrusion in the first direction may be the same as a shape of the thickness in the second direction. In this case, the cross section of the protrusion 1110B in a direction perpendicular to the axial direction may have a square shape.

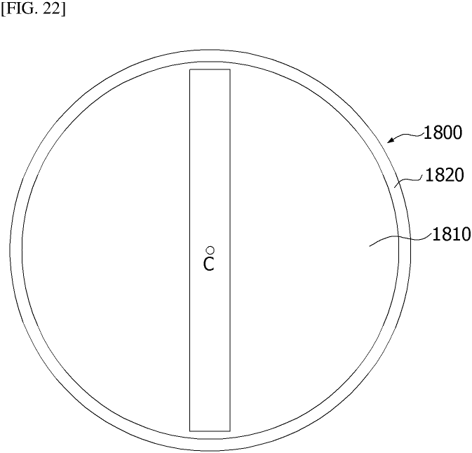

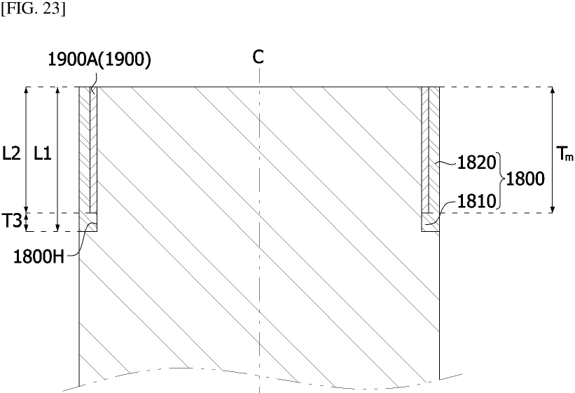

FIG. 22 is a plan view illustrating the holder according to another embodiment of the present invention, and FIG. 23 is a cross-sectional view illustrating the shaft, the holder, and the magnet according to another embodiment of the present invention.

Referring to FIGS. 22 and 23, the holder 1800 may include a first part 1810 and a second part 1820.

The protrusion 1110B passes through the first part 1810. The first part 1810 may be disposed between the magnet 1900 and the shaft 1100. Based on the drawings, an upper surface of the first part 1810 is in contact with the magnet 1900, and a lower surface of the first part 1810 may be in contact with the end portion of the shaft 1100. The first part 1810 may have a diameter which is the same as a diameter of the end portion of the shaft 1100. In this case, the first part 1810 may support the magnet 1900 in the axial direction. The first hole 1800H may be formed in the first part 1810. In addition, the protrusion 1110B passes through the first hole 1800H. A thickness T3 of the first part 1810 in the axial direction may be smaller than a length L1 of the protrusion 1110B in the axial direction. In this case, the end portion of the protrusion 1110B may passes through the first part 1810 to protrude toward the magnet 1900.

The second part 1820 extends from the first part 1810. In addition, the second part 1820 disposed outside the magnet 1900. The second part 1820 may surround an outer circumferential surface of the magnet 1900. The second part 1820 may support the magnet 1900 in a radial direction. A length L2 of the second part 1520 in the axial direction may be smaller than the length L1 of the protrusion 1110A of the magnet 1600 in the axial direction. In addition, the length L2 of the second part 1820 in the axial direction may be smaller than or equal to a thickness Tm of the magnet 1900 in the axial direction. In this case, an upper end of the second part 1520 may also be disposed at a lower level than an upper surface of the magnet 1600.

The first part 1810 and the second part 1820 may form a space. In addition, the protrusion 1110B may be disposed in the space formed by the first part 1810 and the second part 1820. In addition, the space may be divided into two spaces by the protrusion 1110B. In this case, the first magnet 1900A may be disposed in the space at one side with respect to the protrusion 1110B. In addition, the second magnet 1900B may be disposed in the space at the other side with respect to the protrusion 1110B. Accordingly, a length between a magnet holder and the shaft can be reduced in the axial direction, and a size of a motor in the axial direction can be reduced. In addition, the magnet can be physically fixed to the shaft to prevent slip of the magnet and can improve the detection performance of a magnetic element.

As described above, the motor according to the embodiments of the present invention has been specifically described with reference to the accompanying drawings.

The above-described embodiments should be considered in a descriptive sense only and not for purposes of limitation, and the scope of the present invention is defined not by the detailed description but by the appended claims. In addition, it should be interpreted that the scope of the present invention encompasses all modifications and alterations derived from meanings and the scope and equivalents of the appended claims.

1. A motor comprising:
a shaft;
a rotor couped to the shaft;
a stator disposed to correspond to the rotor;
a sensing magnet coupled to the shaft; and
a substrate including a sensor part disposed to correspond to the sensing magnet,
wherein the sensing magnet includes an inner surface and an outer surface,
the inner surface of the magnet is in contact with an outer surface of the shaft, and
the sensor part is disposed further outward than the outer surface of the sensing magnet in a radial direction,
wherein some of a plurality of sensor parts are disposed on a first circumference about the shaft, and the rest of the plurality of sensor parts are disposed on a second about the shaft, and the rest of the plurality of sensor parts are disposed on a second circumference and a radius of the second circumference is different from a radius of the first circumference.

2. A motor comprising:
a shaft;
a rotor couped to the shaft;
a stator disposed to correspond to the rotor;
a sensing magnet coupled to the shaft; and
a substrate including a sensor part disposed to correspond to the sensing magnet,
wherein the sensing magnet includes an inner surface and an outer surface,
the inner surface of the magnet is in contact with an outer surface of the shaft, and
the sensor part is not disposed to overlap the shaft in an axial direction in a range in which the sensor part is disposed within a radius of the rotor,
wherein some of a plurality of sensor parts are disposed on a first circumference about the shaft, and the rest of the plurality of sensor parts are disposed on a second circumference and a radius of the second circumference is different from a radius of the first circumference.

3. The motor of claim 1,
wherein the sensing magnet includes a first sensing magnet and a second sensing magnet which overlaps the first sensing magnet in an axial direction, and
the sensor part includes a first sensor disposed to correspond to the first sensing magnet and a second sensor disposed to correspond to the second sensing magnet.

4. The motor of claim 1, further comprising a bearing which supports the shaft,
wherein a separation distance between the bearing and the rotor is greater than a separation distance between the substrate and the rotor in an axial direction.

5. The motor of claim 4, wherein the substrate is disposed between the sensing magnet and the bearing in the axial direction.

6. A shaft;
a rotor coupled to the shaft;
a stator disposed to correspond to the rotor;
a holder disposed at one side of the shaft; and
a magnet disposed in the holder,
wherein the shaft includes a protrusion disposed on a surface facing the magnet,
the holder includes a first hole through which the protrusion passes, and the magnet includes a space in which the protrusion is disposed,
wherein the holder include a first part and a second part which extends from the first part in the axial direction and surrounds an outer circumferential surface of the magnet,
wherein the first, part include the first hole.

7. The motor of claim 6, wherein:
the magnet includes a first pole and a second pole; and
the protrusion is disposed between the first pole and the second pole.

8. The motor of claim 6, wherein:
the magnet includes a second hole in which the protrusion is disposed; and
an inner surface of the second hole of the magnet is in contact with at least one surface of the protrusion.

9. The motor of claim 6, wherein:
the magnet includes a first magnet and a second magnet, and
the protrusion is disposed between the first magnet and the second magnet.

10. The motor of claim 9, wherein:
the protrusion is disposed in the holder;
the holder is divided into a first space and a second space based on the protrusion;
the first magnet is disposed in the first space, and
the second magnet is disposed in the second space.
